(19) United States
(12) Patent Application Publication
(10) Pub. No.: US 2006/0098824 A1
(43) Pub. Date: May 11, 2006

(54) Method and apparatus for providing short-term private keys in public key-cryptographic systems

(75) Inventor: Wenbo Mao, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/259,246

(22) Filed: Oct. 27, 2005

(30) Foreign Application Priority Data
Oct. 28, 2004 (GB) 0423889.5

(51) Int. Cl. H04L 9/00

(52) U.S. Cl. 380/282

(57) ABSTRACT

A computing entity has an associated static public/private key-pair formed by a static private key comprising a secret, and a static public key comprising both a first element and that element combined with the secret. The secret is stored in higher-security storage provided, for example, by a smartcard. A short-term private key is provided for use by a computing entity in effecting cryptographic operations during an operational period. This short-term private key is generated, independently of any pending cryptographic operations, by mapping a string to a second element and multiplying that element by said secret, the first and second elements being such that a computable bilinear map exists for these elements. The short-term private key is stored in lower-security storage in the computing entity for a limited period that encompasses the operational period in respect of which the key was generated.

### FIELD OF THE INVENTION

The present invention relates to a method and apparatus for providing short-term private keys in public-key cryptographic systems.

### BACKGROUND OF THE INVENTION

Public-key cryptographic systems are well known and involve the use of a public/private key-pair associated with a particular party. More particularly, assuming that the public/private key-pair is associated with a first party, Alice, and that Alice holds the private key and keeps it secret, a second party, Bob, can use the public key both to send a message in confidence to Alice, and to verify a digital signature applied by Alice to a message using her private key. Such a system relies on Bob trusting the association between the public key and Alice and this is often achieved by the use of a digital certificate issued and signed by a certification authority using their own public key. Of course, for Bob to trust the certificate, Bob must trust the association of the public key used to sign the certificate with the certification authority; this association may therefore itself be subject of a further certificate issued by a higher certification authority and so on up a hierarchy of certification authorities until a root authority is reached. The infrastructure established by the hierarchy of certification authorities is referred to as a public key infrastructure, often abbreviated to “PKI”. In fact, a PKI will generally also take care of key management issues such as generating and distributing new keys, and revoking out-of-date keys. Due to the overhead involved in issuing and revoking keys, it is generally impractical with a large-scale PKI for keys to be updated frequently. According, private keys must be stored securely to ensure that they can have a long operational lifetime.

Whilst appropriate key-storage security measures can be implemented by large organisations, individual users will generally only have available equipment, such as a standard personal computer, that provides only weak protection for stored data unless special measures are taken. For example, a private key stored in a personal computer without special protection measures will only be protected by the conventional file access protection mechanisms.

By way of a compromise, the storage of a cryptographic private key in a weakly protected environment may be considered acceptably secure if the key has a short operational lifetime (for example, one day or one hour). However, as indicated above, a short lifetime for the private key of a public/private key-pair is incompatible with the practicalities of public key infrastructures.

It is an object of the present invention to alleviate the foregoing difficulties.

As will become apparent hereinafter, embodiments of the present invention make use of cryptographic techniques using bilinear mappings. Accordingly, a brief description will now be given of certain such prior art techniques.

In the present specification, G₁ and G₂ denote two algebraic groups of large prime order ι in which the discrete logarithm problem is believed to be hard and for which there exists a non-degenerate computable bilinear map p, for example, a Tate pairing or Weil pairing. Note that G₁ is a [ι]-torsion subgroup of a larger algebraic group G₀ and satisfies [ι]P=0 for all PεG₁ where O is the identity element, ι is a large prime, and ι*cofactor=number of elements in G₀. The group G₂ is a subgroup of a multiplicative group of a finite field.

For the Weil pairing: the bilinear map p is expressed as
p: G₁×G₁→G₂.

The Tate pairing can be similarly expressed though it is possible for it to be of asymmetric form:
p: G₁×G₀→G₂

Generally, the elements of the groups G₀ and G₁ are points on an elliptic curve (typically, though not necessarily, a supersingular elliptic curve); however, this is not necessarily the case.

As is well known to persons skilled in the art, for cryptographic purposes, modified forms of the Weil and Tate pairings are used that ensure p(P,P)≠1 where PεG₁; however, for convenience, the pairings are referred to below simply by their usual names without labeling them as modified. Further background regarding Weil and Tate pairings and their cryptographic uses can be found in the following references:
G. Frey, M. Müller, and H. Rück. The Tate pairing and the discrete logarithm applied to elliptic curve cryptosystems. IEEE Transactions on Information Theory, 45(5):1717-1719, 1999.
D. Boneh and M. Franklin. Identity based encryption from the Weil pairing. In Advances in Cryptology—CRYPTO 2001, LNCS 2139, pp. 213-229, Springer-Verlag, 2001.

For convenience, the examples given below assume the use of a symmetric bilinear map (p: G₁×G₁→G₂) with the elements of G₁ being points on an elliptic curve of general form y²=x³+ax+b where x and y are variables and a and b are constants; however, these particularities, are not to be taken as limitations on the scope of the present invention.

As the mapping between G₁ and G₂ is bilinear, then for P, Q, RεG₁, both:
p(P+Q,R)=p(P,R)*p(Q,R)
p(P,Q+R)=p(P,Q)*p(P,R)

Furthermore, exponents/multipliers can be moved around. Thus, where aP represents the scalar multiplication of P by an integer a (that is, P added to itself a times), then for integers a, b, cεZ_{ι}:

$$\begin{matrix}{p ( aP , bQ )}^{c} = {p ( aP , cQ )}^{b} \\ = {p ( bP , cQ )}^{a} \\ = {p ( bP , aQ )}^{c} \\ = {p ( cP , aQ )}^{b} \\ = {p ( cP , bQ )}^{a} \\ = {p ( abP , Q )}^{c} \\ = p ( abP , cQ ) \\ = {p ( P , abQ )}^{c} \\ = p ( cP , abQ ) \\ = … \\ = p ( abcP , Q ) \\ = p ( P , abcQ ) \\ = {p ( P , Q )}^{abc}\end{matrix}$$

Additionally, the following cryptographic hash functions are defined:
H₁: {0,1)*G₁
H₂: {0,1)*Z*_{ι}
H₃: G₂→{0,1)*

The function H₁( ) is often referred to as the map-to-point function as it serves to convert a string input to a point on the elliptic curve being used.

A normal public/private key-pair can be defined for a trusted authority:
the private key is s
   where sεZ_{ι} and
the public key is (P, R)
   where P and R are respectively master and derived public elements
   with PεG₁ and RεG₁, P and R being related by R=sP

Additionally, an identifier based public key/private key-pair can be defined for a party with the cooperation of the trusted authority. As is well known to persons skilled in the art, in “identifier-based” cryptographic methods a public, cryptographically unconstrained, string is used in conjunction with public data of a trusted authority to carry out tasks such as data encryption or signing. The complementary tasks, such as decryption and signature verification, require the involvement of the trusted authority to carry out computation based on the public string and its own private data In message-signing applications and frequently also in message encryption applications, the string serves to “identify” a party (the sender in signing applications, the intended recipient in encryption applications); this has given rise to the use of the label “identifier-based” or “identity-based” generally for these cryptographic methods. However, at least in certain encryption applications, the string may serve a different purpose to that of identifying the intended recipient and, indeed, may be an arbitrary string having no other purpose than to form the basis of the cryptographic processes. Accordingly, the use of the term “identifier-based” herein in relation to cryptographic methods and systems is to be understood simply as implying that the methods and systems are based on the use of a cryptographically unconstrained string whether or not the string serves to identify the intended recipient. Furthermore, as used herein the term “string” is simply intended to imply an ordered series of bits whether derived from a character string, a serialized image bit map, a digitized sound signal, or any other data source.

In the present case, the identifier-based public/private key-pair defined for the party has a public key Q_{ID} and private key S_{ID} where Q_{ID}, S_{ID}εG₁. The trusted authority's normal public/private key-pair (P,R/s) is linked with the identifier-based public/private key by
S_{ID}=sQ_{ID} and Q_{ID}=H₁(ID)
where ID is the identifier string for the party.

Some typical uses for the above described key-pairs will now be given with reference to FIG. 1 of the accompanying drawings that depicts a trusted authority 1 with a public key (P, sP) and a private key s. A party A serves as a general third party whilst for the identifier-based cryptographic tasks (IBC) described, a party B has an IBC public key Q_{ID} and an IBC private key S_{ID}, this latter key being generated by private-key generation functionality of the trusted authority 1 from the identifier ID of party B. The trusted authority will generally only provide the party B with its private key after having checked that party B is entitled to the identifier ID (for example, by having verified that party B meets certain conditions specified in the identifier, such as an identity condition).

Short Signatures (see dashed box 2): The holder of the private key s (that is, the trusted authority 1 or anyone to whom the latter has disclosed s) can use s to sign a bit string; more particularly, where m denotes a message to be signed, the holder of s computes a signature element Sig as follows:
Sig=sH₁(m).

Verification by party A involves this party checking that the following equation is satisfied:
p(P,Sig)=p(R,H₁(m))

This is based upon the mapping between G₁ and G₂ being bilinear exponents/multipliers, as described above. That is to say,

$$\begin{matrix}p ( P , Sig ) = p ( P , {sH}_{1} ( m ) ) \\ = {p ( P , {H}_{1} ( m ) )}^{s} \\ = p ( sP , {H}_{1} ( m ) ) \\ = p ( R , {H}_{1} ( m ) )\end{matrix}$$

Further description of short signatures of this form can be found in “Short signatures from the Weil pairing”, Boneh, D., B. Lynn, and H. Shacham, in Advances in Cryptology—ASIACRYPT '01, LNCS 2248, pages 514-532, Springer-Verlag, 2001.

Identifier-Based Encryption (see dashed box 3):—Identifier based encryption allows the holder of the private key S_{ID} of an identifier based key-pair (in this case, party B) to decrypt a message sent to them encrypted (by party A) using B's public key Q_{ID}.

More particularly, party A, in order to encrypt a message m, first computes:
U=rP
where r is a random element of Z*_{ι}. Next, party A computes:
V=m⊕H₃(p(R,rQ_{ID}))
Party A now has the ciphertext elements U and V which it sends to party B.

Decryption of the message by party B is performed by computing:

$$\begin{matrix}V ⊕ {H}_{3} ( p ( U , {S}_{ID} ) ) = V ⊕ {H}_{3} ( p ( rP , {sQ}_{ID} ) ) \\ = V ⊕ {H}_{3} ( {p ( P , {Q}_{ID} )}^{rs} ) \\ = V ⊕ {H}_{3} ( p ( sP , {rQ}_{ID} ) ) \\ = V ⊕ {H}_{3} ( p ( R , {rQ}_{ID} ) ) \\ = m\end{matrix}$$

The foregoing example encryption scheme is the “Basicldent” scheme described in the above-referenced paper by D. Boneh and M. Franklin. As noted in that paper, this basic scheme is not secure against a chosen ciphertext attack (the scheme only being described to facilitate an understanding of the principles involved—a fully secure scheme is described later on in the paper and the reader should refer to the paper for details).

Identifier-Based Signatures (see dashed box 4):—Identifier based signatures using pairings can be implemented. For example:

Party B first computes:
g=p(P,S_{ID})^{r}
where r is a random element of Z*_{ι}.

Party B then applies the hash function H₂ to m∥g (concatenation of m and g, with g having been first converted to string form) to obtain:
h=H₂(m∥g)
Thereafter party B computes
W=(r−h)S_{ID}
thus generating the output Wand h as the signature on the message m.

Verification of the signature by party A can be established by computing:
g′=P(P,W)*p(R,Q_{ID})^{h}
where the signature can only be accepted if h=H₂ (m∥g).

### SUMMARY OF THE INVENTION

According to one aspect of the present invention, there is provided a method of providing a short-term private key for use by a computing entity in effecting cryptographic operations during an operational period, said entity having an associated static public/private key-pair formed by a static private key comprising a secret stored in higher-security storage and a static public key comprising both a first element and that element combined with said secret; the method comprising:
generating said short-term private key, independently of any pending cryptographic operations, by mapping a string to a second element and multiplying that element by said secret, the first and second elements being such that a computable bilinear map exists for these elements;
storing the short-term private key in lower-security storage, provided by said entity, for a limited period comprising said operational period.

It will be appreciated that the association of the static public/private key-pair with the computing entity may be indirect, the key-pair being principally associated (for example, by a digital certificate issued by a certification authority) with a particular party that has elected to use the computing entity.

Preferably, the higher-security storage is provided by a memory card or a smartcard, the lower-security storage being, for example, part of a standard file system of the computing entity. Because the short-term private key is only used and stored in lower-security storage for a limited period, the overall security risk is bounded and is balanced against the greater availability of the operational private key.

A second computing entity wishing to carry out a cryptographic transaction with the first-mentioned computing entity during the aforesaid operational period in which the first-mentioned computing entity is arranged to use the short-term private key for cryptographic operations, can do so by using the aforesaid second element and at least the component of the static public key formed by combining the first element and said secret. The continued involvement of this combined component ensures the continued validity of any assurance provided (for example, through a public key certificate) to the second computing entity about the association of the static public key with the first-mentioned computing entity or with a party using that entity. With regard to the second element, this latter can either be independently generated by the second computing entity or fetched from the first-mentioned computing entity.

According to another aspect of the present invention, there is provided a method of providing a short-term private key for use by computing apparatus during an operational period, said apparatus having an associated static public/private key-pair formed by a static private key comprising a secret stored in higher-security storage and a static public key comprising both a first element of a first algebraic group and the product of this element with said secret; the method comprising:
generating said short-term private key by mapping a string, based on data known in advance of said operational period or generated at said apparatus, to a second element of a second algebraic group that comprises said first algebraic group, and multiplying the second element by said secret; the first and second elements being such that a computable bilinear map exists for these elements;
storing the short-term private key in lower-security storage, provided by said computing apparatus, for the duration of a limited period comprising said operational period.

According to a further aspect of the present invention, there is provided a cryptographic method wherein a second party generates a short-term public key element and uses it during an operational period in effecting cryptographic operations pertaining to a first party that has an associated static public/private key-pair formed by a static private key comprising a secret, and a static public key comprising both a first element and that element combined with said secret; the method comprising the second party:
deriving a string based, in a predetermined manner, on data known in advance of said operational period; and
mapping the string to said short-term public key element, the first element and the short-term public key element being such that a computable bilinear map exists for these elements;
during said operation period, using the short-term public key element and said static public key to carry out any required cryptographic operation pertaining to the first party in such a manner that there exists a complimentary operation requiring knowledge of the short-term public key element and said secret for its execution.

According to a still further aspect of the present invention, there is provided a cryptographic system comprising:
a first entity arranged to use the private key of an associated static public/private key pair to form a plurality of different short-term private keys each for use during a corresponding limited operational period;
a public key infrastructure for providing a certificate associating the first entity with the public key of its static public/private key-pair; and
a second entity arranged to use a known formula and known data to migrate the static public key of the first entity, whilst retaining the assurance provided by said certificate, to form short-term public keys each for use, during a corresponding said limited operational period, in carrying out cryptographic operations for which there exist complimentary operations requiring use of the corresponding short-term private key.

Each of the first and second entities can be a person or organisational entity acting through a computing agent, or a computing entity itself.

According to a yet further aspect of the present invention, there is provided a certificate authority of a public key infrastructure, the certificate authority being arranged to provide certificates each certifying an association between an identified entity and the public key of a static public/private key-pair the private key of which is held by the identified entity, at least one certificate also including a formula by which the corresponding public key is to be migrated to form short-term public keys each for use during a corresponding limited operational period in carrying out cryptographic operations pertaining to the identified entity concerned.

### BRIEF DESCRIPTION OF THE DRAWINGS

Embodiments of the invention will now be described, by way of non-limiting example, with reference to the accompanying diagrammatic drawings, in which:

FIG. 1 is a diagram showing prior art cryptographic processes based on elliptic curve cryptography; and

FIG. 2 is a diagram illustrating an embodiment of the invention.

### BEST MODE OF CARRYING OUT THE INVENTION

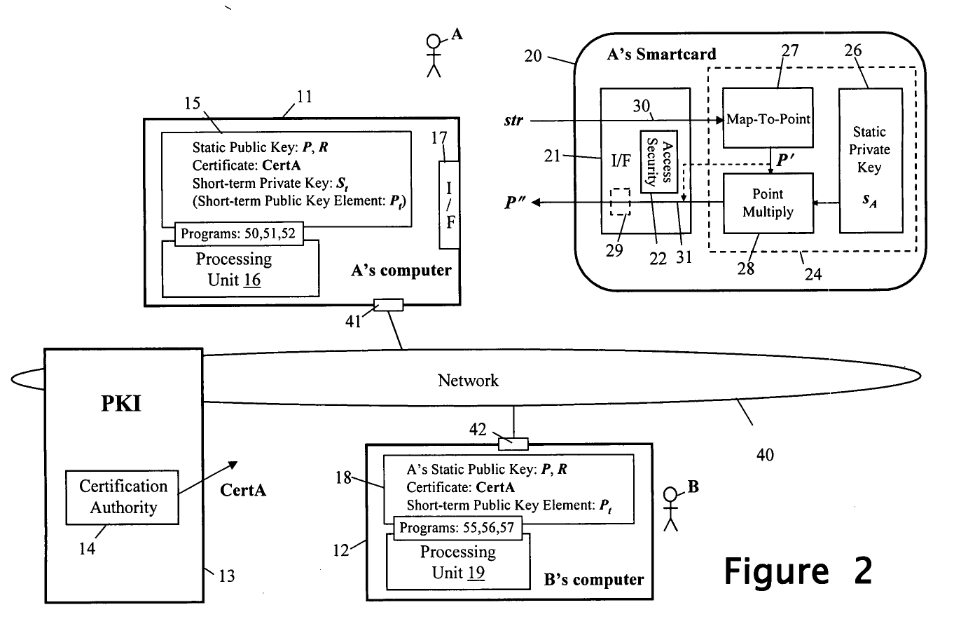

FIG. 2 illustrates an arrangement in which a first party A (‘Alice’) with smartcard 20 has use of a first computing entity 11, and a second party B (‘Bob’) has use of a second computing entity 12; by way of example, both computing entities are desktop computers or portable computers. The computing entity 11 comprises a conventional file system 15 for managing data and programs held on a mass storage device, a processing unit 16, a network interface 41, and a smartcard interface 17 with which the smartcard 20 can be detachably engaged for the exchange of data with the computing entity 11. The computing entity 12 comprises a conventional file system 18, a processing unit 19, and a network interface 42. The computing entities 11 and 12 inter-communicate, for example, via the internet or other computer network 40 though it is also possible that the entities actually reside on the same computing platform or that communication between entities is effected by the physical transfer of a data storage medium.

A long-term or “static” public/private key-pair is associated with Alice. The static private key s_{A} of this key-pair is stored in Alice's smartcard 20 (a relatively high-security environment) whilst the static public key of the key-pair is stored in the file system 15 of Alice's computer 11 (that is, the static public key is stored on the mass storage device of the computer, a relatively low-security environment from where it is accessible under the same limited access control restrictions as the normal files of the computer).

Alice's static public key comprises a first component P constituted by a first point on a predetermined elliptic curve, and a second component R constituted by the scalar product of the point P with the secret s_{A}, this second component R(=s_{A}P) also being a point on the predetermined elliptic curve. As is well known in the field of elliptic curve cryptography, because the discrete logarithm problem is hard, a third party given P and s_{A}P cannot discover s_{A} from s_{A}P.

Alice's static public key (P, R) is, for example, initially generated using the smartcard 20 with its installed secret s_{A}. Alternatively, both Alice's static private key s_{A} and static public key (P, R) can be created by a trusted third party and then installed respectively in the smartcard 20 and computing entity 11. However Alice's static public/private key-pair is created, a certification authority 14 of a public key infrastructure 13 is arranged to issue a certificate CertA (for example, an X.500 certificate) that vouches for the association of the static public key (P,R) with Alice after having checked this association. Conveniently, the certification authority 14 itself generates Alice's static key-pair and issues the key-pair in a secure way to Alice along with a copy of the certificate CertA.

Alice's computer 11 also holds in its file system 15 the current version of a short-term private key Sₜ and, optionally, a corresponding short-term public key element Pₜ. These short-key public and private key elements are used by the computer 11 to carry out cryptographic operations during a short operational period, for example, one calendar day or one hour, before being superseded; holding the current versions of the short-term public and private key elements in the file system 15 has the advantage that they are readily accessible to the processing unit 16. Key management functionality of the computer 11 ensures that each version of the short-term private key is only held in the relatively insecure file system 15 of the computer 11 for a limited period that encompasses the operational period to which it applies; thereafter, that version of the short-term private key is either destroyed or removed to a more secure storage. By only using any one version of the short-term public and private key elements for a limited operational period, and by only keeping that version of the short-term private key in the low security file system for a limited period, the overall security risk of holding an operational private key in the low security file system is minimised. How the short-term keys are created and used will be described hereinafter.

Bob's computer 12 also stores Alice's static public key (P,R) in its file system 18 along with the certificate CertA, these data having been obtained either from Alice's computer 11 or from another source such as the certification authority 14. In standard manner, Bob can choose to rely on the certificate CertA as verifying the association of the static public key (P,R) with Alice but should only do so after verifying that the certificate CertA has indeed been signed by the certification authority 14 (which may require reference to other, higher-level, certification authorities of the PKI 13).

The file system 18 of Bob's computer may also hold Alice's current short-term public key element Pₜ, Bob's computer 11 having either fetched this key element from Alice's computer 11 or independently created it. Although Bob's computer 12 can be arranged to fetch or create Alice's current short-term public key element as and when required without referring to the file system 18, it will generally be more efficient to hold the short-term public key element Pₜ, once obtained, in the file system 18 since even though the operational period of the key element Pₜ is only short term, multiple usages of the key element Pₜ during the period are still likely following a first usage.

Before describing the creation and usage of the short-term key elements Pₜ and Sₜ, a description will be given of Alice's smartcard 20. As used herein, the term “smartcard” is intended to include any small-sized device (such as a credit-card sized object) incorporating memory and processing functionality, usually on a single chip, that is externally accessible by any suitable interface whether using physical contacts or non-contact means. Preferably, at least the memory will be tamper resistant/tamper proof.

The smartcard 20 comprises an input/output interface functional block 21 and a cryptographic functional block 24 (shown in dashed outline).

The interface block 21 comprises a data input channel 30, a data output channel 31, and an access security entity 22. The interface block 21 is adapted to permit the smartcard to be coupled with the smartcard interface 17 provided on the computer 11. The access security entity 22 is, for example, implemented to require the input of a PIN code before allowing use of the smartcard, this code being input by a user (in this case, Alice) via apparatus with which the smartcard is operatively coupled.

The input channel 30 is arranged to receive a cryptographically unconstrained input string (generically, string str) whilst the output channel 31 is arranged to output an element P″. The form in which the element P″ is output can be set by entity 29 of interface block 11 to be, for example, of string form.

The cryptographic block 24 of smartcard 20 comprises the following functional entities:
a non-volatile memory 26 for holding the secret s_{A} (for example, installed in the card during manufacture, generated at initialization of the card by suitable random number generation circuitry provided on the card, or loaded into the card at initialization via a suitable interface);
a Map-To-Point entity 27 for receiving the string str from the input channel 30 and mapping this string to an element P′ of an algebraic group according to a known one-way mapping function;
a product entity 28 for multiplying the element P′ by the stored secret s_{A} to form a further element P″ of the same algebraic group as the element P′, the element P″ being output on output channel 31 (as indicated in dashed lines, the element P′ can also be arranged to be output on channel 31).

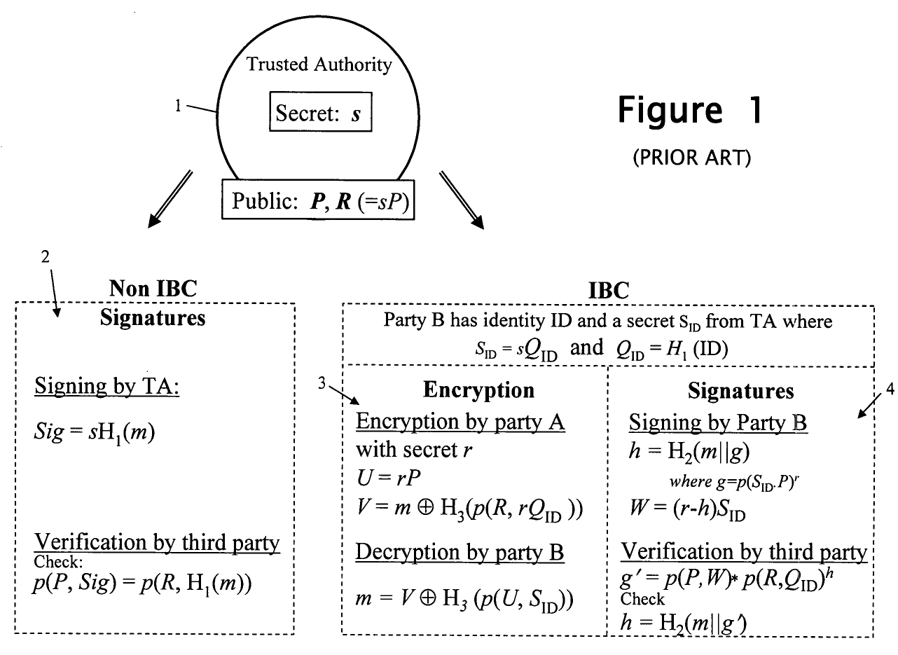

Preferably, the elements P″ and P″ are points on the same elliptic curve of general form y²=x³+ax+b where x and y are variables and a and b are constants. The various hash functions already described above with reference to the FIG. 1 examples will be used for the examples given below; in particular, the map-to-point function implemented by entity 27 is the hash function H₁( ).

Various usages of a smartcard of the above-described form are set out in our co-pending published US patent application No. 2005/0102523 (published may 12, 2005).

By its very nature, the smartcard 20 provides a more secure storage environment for Alice's static private key s_{A} than the file system 15 of the computer 11. Features that contribute to this greater security include:
the personal nature and portability of the smartcard 20 enabling Alice to keep it with her at all times (whilst the computer 11 may be portable it may not be personal and is far less convenient to be kept by Alice at all times);
the limited external computer access possibilities to the smartcard consequent on the fact that the smartcard is only vulnerable to such access when interfaced with a computer and that the card will generally only need to interface with a computer for short periods;
the inherently tamper-resistant nature of the memory used to store the secret s_{A} (in contrast, it is a relatively simple matter to read data from the mass storage device of computer 11 if physical access to that device is possible);
the more reliable access control features (PIN etc) provided on the smartcard (whilst most computers do provide access control features, these are often not activated whereas those provided on a smartcard cannot generally be de-activated by the user).

Any one or more of these features results in the smartcard 20 being more secure for storage of the secret s_{A} than the file system 15 of the computer 11. It will also be noted that because the smartcard 20 includes the required functionality for effecting point multiplication, the secret s_{A} does not need to be copied into the computer 11 at any stage.

Consideration will now be given as to how Alice's short-term key elements are generated and used.

In order to generate a short-term private key Sₜ for an operational period such as the current day, Alice inserts her smartcard 20 into the interface 17 of the computer 11 and activates a key generation program 50 for execution by the processing unit 16. Key generation then proceeds as follows:
the computer 11 generates a string (str)ₜ which in a preferred embodiment is a concatenation of the x coordinate Pₓ of the point P (a component of Alice's static public key) and the current date:
   (str)ₜ=Pₓ∥current date
the string (str)ₜ is passed to the smartcard 20 which maps the string (str)ₜ to a point Pₜ on the same elliptic curve as P using the map-to-point hash function H₁( ), and multiplies the point Pₜ by the secret s_{A}, the result being output on channel 31 as the short-term private key Sₜ:
   Pₜ=H₁((str)ₜ)
   Sₜ=s_{A}Pₜ
the short-term private key Sₜ is stored in the file system 15 of the computer 11;
the point Pₜ can also be output by the smartcard 20 and stored in the file system 15 as the short-term public key element corresponding to Sₜ; alternatively, the program 50 can be arranged to compute Pₜ itself for storage in the file system 15 or as and when required.

The program 50 is also arranged to set the operational period over which the current short-term key elements are to be used by the computer 11 for cryptographic operations. Thus, the program 50 provides a user interface for enabling the Alice to specify the operational period (or defaults to a suitably short period); the program 50 is also responsible for automatically removing at least the short-term private key Sₜ from the file system 15 at the end of the associated operational period (the program 50 thus provides the above-mentioned key management functionality).

It will be appreciated that generally (though not necessarily) there will be multiple successive operational periods during which the computer 11 is to carry out cryptographic operations using short-term keys based on the same static public/private key-pair. It will be further appreciated that the short-term keys for different operational periods should differ from each other; in this respect, it may be noted that where there is only one operational period per calendar day, then the foregoing formula for the string (str)ₜ ensures that the string, and thus the short-term private key Sₜ, will be unique for each operational period. Bob's computer 12 is arranged to run a program 55 to generate Alice's short-term public key element Pₜ for the current operational period of Alice's computer 11 either for storage in the file system 18 and subsequent use as and when required, or simply as and when required. This, of course, requires Bob's computer 12 to know the formulaic basis and data upon which Alice's computer creates the string (str)ₜ and this information is preferably obtained in advance or is predictable (for example, in the present case the formula for generating (str)ₜ could be included in the certificate certA or obtained from the computer 11, whilst the component Pₓ will already be available as part of Alice's static public key and the date component will be known). Bob's computer 12 preferably also knows the extent of the operational period for which the short-term public key element is valid, this information being obtained in the same way as that required for constructing the string (str)ₜ.

As will become apparent hereinafter, in order for Bob's computer to carry out cryptographic operations during an operational period that complement operations executed or to be executed by Alice's computer using the short-term private key Sₜ for the period concerned, Bob's computer must utilise Alice's static public key (P, R) as well as the short-term public key element Pₜ determined for the period concerned. It is therefore convenient to consider the short-term public key for an operational period to be made up not only of the element Pₜ but also of the elements P and R from Alice's static public key; in other words, the short-term public key comprises (P, R, Pₜ).

Two example cryptographic processes will now be described that make use of Alice's current short-term private key Sₜ and short-term public key (P,R, Pₜ). Each process comprises a cryptographic operation carried out by one of Alice's and Bob's computers 11, 12 and a subsequent complimentary cryptographic operation carried out by the other of Alice's and Bob's computers 11, 12. These cryptographic operations are typically carried out by corresponding programs running on the processors of the computers 11, 12 but can alternatively be implemented by dedicated hardware of the computers 11, 12; in either case, the computers 11, 12 are effectively provided with cryptographic units for carrying out cryptographic operations.

Encryption/Decryption

This encryption/decryption process is similar to that described above with reference to dashed box 3 of FIG. 1. Suppose that Bob wishes to send confidential subject data (message m) to Alice. To do this, Bob initiates the running of an encryption program 56 by the processing unit 19 of computer 12, this program being supplied with the message m as input and having access to and Alice's short-term public key (P, R, Pₜ) in a manner already described above. Under the control of program 56, Bob's computer 12:
generates a random secret r where rεZ_{ι},
computes:
   U=rP
computes a key kₜ applicable to the current operation period:
   kₜ=H₃(p(R,rPₜ))
where p ( ) is a bilinear mapping function (for example, Weil or Tate pairing), and H₃( ) is the hash function previously defined;
uses the key kₜ to encrypt the message m using encryption function E( ):
   V=E(kₜ,m)
where an example encryption function is the Exclusive OR function ⊕:
   V=m⊕kₜ
though other functions are, of course, possible;
sends U and V to Alice's computer 11.

Bob can trust that only Alice (that is, only a computing entity associated with Alice, such as computer 11) can decrypt the encrypted message V because the message has been encrypted using the element R (=s_{A}P) of Alice's public key and requires a knowledge of the secret s_{A} to decrypt it.

To decrypt the encrypted message V, Alice's computer 11 initiates the running of a decryption program 51 by the processing unit 16 of computer 11, this program being supplied with the encrypted message V and the element U as input and having access to Alice's current short-term private key Sₜ in file system 15. Under the control of program 56, Alices' computer 11:
uses the short-term private key Sₜ to computes the key kₜ:
   kₜ=H₃(P(U,Sₜ))
it being straightforward to show that this is equivalent to the computation of the key kₜ made by Bob's computer 12:

$$\begin{matrix}{H}_{3} ( p ( U , {S}_{t} ) ) = {H}_{3} ( p ( rP , {s}_{A} {P}_{t} ) ) \\ = {{H}_{3} ( p ( P , {P}_{t} ) )}^{{rs}_{A}} \\ = {H}_{3} ( p ( {s}_{A} P , {rP}_{t} ) ) \\ = {H}_{3} ( p ( R , {rP}_{t} ) )\end{matrix}$$
decrypts the encrypted message V using decryption function DO:
   m=D(kₜ,V)
which in the case of the example encryption function in the form of the Exclusive OR function, becomes:
   m=V⊕kₜ

Since the decryption process does not involve Alice's static private key s_{A} by itself but only as combined with Pₜ in the short-term private key Sₜ, decryption does not require the presence of the smartcard in the interface 17; thus, decryption can be carried out without Alice being present (which would not be the case if direct use of the secret s_{A} was required as Alice will generally take the smartcard 20 with her when leaving the computer 11).

Signature/Verification

This signature/verification process is similar to that described above with reference to dashed box 4 of FIG. 1. Alice can sign subject data (again, taken to be a message m) such that Bob can verify that the signed message originated from Alice. To do this, Alice initiates the running of a signature program 52 by the processing unit 16 of computer 11, this program being supplied with the message m as input and having access to Alice's current short-term private key Sₜ and Alice's static public key (P,R) in file system 15. Under the control of program 52, Alice's computer 11:
generates a random secret r where rεZ_{ι};
computes:
   g=p(Sₜ,P)^{r}
where p( ) is a bilinear mapping function (for example, Weil or Tate pairing), it being appreciated that a number of equivalent arrangements of the same components are possible;
converts g to a string and computes:
   h=H₂(m∥g)
where H₂( ) is the hash function previously defined;
computes:
   W=(r−h)Sₜ
sends the message m and the signature components W and h to Bob's computer 12.

Again, since the signature process does not involve Alice's static private key s_{A} by itself but only as combined with Pₜ in the short-term private key Sₜ, signing does not require the presence of the smartcard in the interface 17; thus, signing can be carried out without Alice being present.

To verify that the received form m′ of the message is an uncorrupted message sent by Alice, Bob initiates the running of a verification program 57 by the processing unit 19 of computer 12, this program being supplied with the received message m′ and the received signature components W′ and h′ as input and having access to Alice's short-term public key (P, R, Pₜ) in a manner already described above. Under the control of program 57, Bob's computer 12:
computes:
   g′=p(P,W)*p(R,Pₜ)^{h′})
converts g′ to a string and checks whether:
   h′=H₂(m′∥g′)
and if so, the received message is taken to be a message m sent by Alice, otherwise the message is discarded.

Bob can trust that the verification check will only be passed if Alice signed the message because only Alice (that is, only a computing entity associated with Alice, such as computer 11) has access to the secret s_{A} and use of this secret during the signing process is necessary for the verification check to be passed as this check involves the element R (=s_{A}P).

Variants

Many variants are possible to the above-described embodiment of the invention and some of these variants will now be described.

With respect to how the string (str)ₜ is formed for the or each operational period, there are three main considerations:
Firstly, Alice (that is, Alice's agent computer 11) must be able to derive the string (str)ₜ independently of any pending cryptographic operation since no such operations may be pending when Alice is present with her smartcard 20. Thus, the string (str)ₜ should not be derived, for example, on the basis of Bob sending an encrypted message along with a string to be used to form the key for decrypting that message.
Secondly, Bob as well as Alice must be able to derive or obtain the string (str)ₜ. This can be achieved by Alice and Bob agreeing in advance a formula for the deriving the string, the formula using data that is either available or obtainable by both Alice and Bob. Alternatively, Alice and Bob can simply agree in advance a set of one-time strings that they will use, each party then storing the set and taking a string for use from the set as and when needed. A further possibility is that Alice is in sole control of determining the string and Bob must obtain the string from Alice as and when needed.
Thirdly, where there are multiple operational periods, there should be a high probability that the string used for any one period is different to that used for any other period (and preferably is unique). Uniqueness can be guaranteed by incorporating into the string (str)ₜ a date or time of the period concerned as measured from a reference that is the same for all operational periods. However, this is not the only way of ensuring uniqueness—for example, an incrementing count of the operational periods will also provide uniqueness. It would also be possible, at least in theory, to store all previously used strings and then randomly choose a candidate string for a next operational period but only use it if found to be unique as compared with the previously used strings. In fact, provided that the probability of repeated occurrence of a particular string is low, a random technique can be used to generate the string (str)ₜ without the need to effect a comparison with previously-used string; this is because the concern is to achieve a particular degree of security so that if other factors permit, some relaxation of the uniqueness criterion is possible.

Thus, whilst the previously given formula for (str)ₜ involving the x coordinate of the point P and the current date, is a preferred formulation for the string, neither of these components is in itself essential. As with the given formula for the string (str)ₜ, the string can be composed of multiple components, though it is also possible to use a single component.

With regard to the duration of the or each operational period, this can be set by specific times or by a specific duration; alternatively, the beginning and/or end of an operation period can be triggered by a non-time-related event.

It is to be noted that the short-term private key associated with a given operational period can be held in the low-security storage represented by the file system 15 of computer 11 for a limited period that is greater than the operational period itself; this is because, the degree of security required may allow for such longer retention. Thus, it may be convenient to allow for a short-term private key to be created and stored in the file system 15 in advance of the operational period to which it applies so that where Alice knows in advance that she will not be present (and thus her smartcard will not be available) at the time of the next operational period, Alice can cause the short-term private key for that period to be generated in advance and stored ready for the commencement of the operational period.

It will be appreciated that whilst in the described embodiment Alice's static private key s_{A} has been stored in a smartcard, other relatively secure storage environments can be used to store the static private key. Other suitable secure storage environments include a memory stick (such as a USB memory stick) or other removable memory device, and encrypted storage in the computer 11 with decrypted access requiring the presence of Alice (as tested, for example, biometrically or in some other manner).

The short-term private key Sₜ need not be stored in the file system of a computer and can be held in any suitable storage providing an acceptable degree to security. It will be appreciated that the required level of security of the storage used for the short-term private key Sₜ is less than that required for the storage used for the static private key s_{A}.

It should also be noted that other reasons may exist for using migrating short-term keys besides that of wishing to use the more-accessible but less secure file system of Alice's computer for private-key storage. For example, Alice may wish to delegate her work to subordinates by giving each a short-term private key for a respective period for which they are responsible; each subordinate may store the short-term private key in storage of equal security to that used by Alice for her static private key. In such a situation, key migration still provides advantages even though the short-term private keys may not be any more accessible, or any more insecure, than the static private key.

1. A method of providing a short-term private key for use by a computing entity in effecting cryptographic operations during an operational period, said entity having an associated static public/private key-pair formed by a static private key comprising a secret stored in higher-security storage and a static public key comprising both a first element and that element combined with said secret; the method comprising:
generating said short-term private key, independently of any pending cryptographic operations, by mapping a string to a second element and multiplying that element by said secret, the first and second elements being such that a computable bilinear map exists for these elements;
storing the short-term private key in lower-security storage, provided by said entity, for a limited period comprising said operational period.

2. A method according to claim 1, wherein the computing entity includes a device interface, said higher-security storage being provided by a device that is detachably engageable with said device interface of the computing entity whereby to enable a user to remove the higher-security storage device from the computer before leaving it unattended.

3. A method according to claim 2, wherein said higher-security storage device is a smartcard, the generation of said short-term private key being carried out by the smartcard without said secret being passed to the computing entity.

4. A method according to claim 1, wherein the computing entity comprises both said higher-security storage and said lower-security storage, the higher security storage storing said secret in encrypted form with decryption of this secret only being enabled by the user when present.

5. A method according to claim 1, wherein the string is based at least on a time or date related to said operational period.

6. A method according to claim 1, wherein the string is based at least on randomly generated data.

7. A method according to claim 1, wherein the string is based at least on the static public key.

8. A method according to claim 1, wherein the first and second elements are points on an elliptic curve y²=x³+ax+b where x and y are variables and a and b are constants, the string being based at least on the x-coordinate of the first element.

9. A method according to claim 1, wherein respective short-term private keys are generated for multiple operational periods, each short-term key being based on a string that has at least a high probability of uniqueness relative to the strings used in generating the other short-term private keys, and each short-term private key being stored in the lower-security storage for a corresponding said limited period comprising the operational period concerned.

10. A method according to claim 9, wherein said operational periods are successive periods and the string used in generating the short-term private key for each period is based at least on a time or date concerning that period as measured from a predetermined reference that is the same for all operational periods whereby to provide uniqueness to the string.

11. A method according to claim 9, wherein the string used in generating the short-term private key for each period is based at least on a respective random number whereby the resulting string has a high probability of being unique.

12. A cryptographic method comprising:
using the method of claim 1 to provide said computing entity with a short-term private key;
during said operational period, using the computing entity to sign subject data by:
applying a bilinear mapping function to the pair of elements constituted by the short-term private key and the product of a random secret and the first element, or effecting an equivalent bilinear mapping operation using the same components;
forming a first signature component by forming a hash of a combination of the subject data and the result of the bilinear mapping; and
forming a second signature component by multiplying the short-term private key by the difference of said hash and said random number.

13. A cryptographic method comprising:
carrying out the method of claim 1 to provide said computing entity with a short-term private key;
during said operational period using the computing entity to receive and decrypt encrypted message subject data by:
receiving both said encrypted subject data and a further element corresponding to the first element multiplied by a random number;
accessing the lower-security storage to retrieve said short-term private key;
applying a bilinear mapping function to the pair of elements constituted by said further element and the short-term private key, and deriving a decryption key by further mapping the result of the bilinear mapping into an appropriate form; and
decrypting the received encrypted subject data using the decryption key.

14. A cryptographic method comprising:
carrying out the method of claim 1 to provide said computing entity with a short-term private key;
at a second computing entity distinct from the first-mentioned computing entity:
independently generating said second element by independently forming said string and mapping it to said second element;
using the second element together with at least said static public key to carry out a cryptographic operation for which there exists a complimentary operation requiring knowledge of said short-term private key for its execution.

15. A cryptographic method comprising:
carrying out the method of claim 1 to provide said computing entity with a short-term private key;
at a second computing entity distinct from the first-mentioned computing entity,
retrieving said second element from said first-mentioned computing entity or retrieving said string from the first-mentioned entity and mapping it to said second element; and
using the second element together with at least said static public key to carry out a cryptographic operation for which there exists a complimentary operation requiring knowledge of said short-term private key for its execution.

16. A method according to claim 1, wherein the first and second elements are points on the same elliptic curve and said bilinear map is based on a Tate or Weil pairing.

17. Computing apparatus with an associated static public/private key-pair formed by a static private key comprising a secret, and a static public key comprising both a first element and that element combined with said secret; the computing apparatus comprising:
a higher-security storage arrangement for storing said secret;
a cryptographic unit for effecting cryptographic operations during an operational period using a short-term private key;
a key generator for generating said short-term private key, independently of any cryptographic operations pending for said cryptographic unit, by mapping a string to a second element and multiplying that element by said secret, the first and second elements being such that a computable bilinear map exists for these elements;
a lower-security storage arrangement; and
a key manager arranged to cause the short-term private key to be held in the lower-security storage arrangement, for access by the cryptographic unit, for a limited period only, this limited period comprising said operational period.

18. Computing apparatus according to claim 17, wherein the apparatus is physically in the form of a computer with a device interface and a storage device detachably engageable with the device interface; the storage device serving to provide said higher-security storage arrangement, and the computer serving to provide both said cryptographic unit and said key manager.

19. Computing apparatus according to claim 18, wherein the storage device is a smartcard, the smartcard serving to provide the key generator, generation of said short-term private key being arranged to be carried out without said secret leaving the smartcard.

20. Computing apparatus according to claim 17, wherein the apparatus is physically in the form of a computer that serves to provide both said higher-security storage arrangement and said lower-security storage arrangement, the higher security storage arrangement being arranged to store said secret in encrypted form and to decrypt the encrypted secret only in response to appropriate user input.

21. Computing apparatus according to claim 17, wherein the key generator is arranged to generate said string using at least a time or date related to said operational period.

22. Computing apparatus according to claim 17, wherein the key generator includes a random data generator and is arranged to generate said string using at least random data generated by the random data generator.

23. Computing apparatus according to claim 17, wherein the key generator is arranged to generate respective short-term private keys for multiple operational periods, the key generator being arranged to base each short-term key on a string that has at least a high probability of uniqueness relative to the strings used in generating the other short-term private keys, the key manager being arranged to store each short-term private key in the lower-security storage for a corresponding said limited period comprising the operational period concerned.

24. Computing apparatus according to claim 23, wherein said operational periods are successive periods and the key generator is arranged to form the string used in generating the short-term private key for each period using at least a time or date concerning that period as measured from a predetermined reference that is the same for all operational periods whereby to provide uniqueness to the string.

25. Computing apparatus according to claim 23, wherein the key generator includes a random data generator, the key generator being arranged to form the string used in generating the short-term private key for each period using at least random data generated by the random data generator.

26. Computing apparatus according to claim 17, wherein the first and second elements are points on the same elliptic curve and said bilinear map is based on a Tate or Weil pairing.

27. A method of providing a short-term private key for use by computing apparatus during an operational period, said apparatus having an associated static public/private key-pair formed by a static private key comprising a secret stored in higher-security storage and a static public key comprising both a first element of a first algebraic group and the product of this element with said secret; the method comprising:
generating said short-term private key by mapping a string, based on data known in advance of said operational period or generated at said apparatus, to a second element of a second algebraic group that comprises said first algebraic group, and multiplying the second element by said secret; the first and second elements being such that a computable bilinear map exists for these elements;
storing the short-term private key in lower-security storage, provided by said computing apparatus, for the duration of a limited period comprising said operational period.

28. A cryptographic method wherein a second party generates a short-term public key element and uses it during an operational period in effecting cryptographic operations pertaining to a first party that has an associated static public/private key-pair formed by a static private key comprising a secret, and a static public key comprising both a first element and that element combined with said secret; the method comprising the second party:
deriving a string based, in a predetermined manner, on data known in advance of said operational period; and
mapping the string to said short-term public key element, the first element and the short-term public key element being such that a computable bilinear map exists for these elements;
during said operation period, using the short-term public key element and said static public key to carry out any required cryptographic operation pertaining to the first party in such a manner that there exists a complimentary operation requiring knowledge of the short-term public key element and said secret for its execution.

29. A method according to claim 28, wherein there are a succession of operational periods, the second party deriving the short-term public key element afresh for each such period based on a string that is different for each period.

30. A method according to claim 29, wherein the string is based at least on a time or date related to the operational period concerned.

31. A cryptographic system comprising:
a first entity arranged to use the private key of an associated static public/private key pair to form a plurality of different short-term private keys each for use during a corresponding limited operational period;
a public key infrastructure for providing a certificate associating the first entity with the public key of its static public/private key-pair; and
a second entity arranged to use a known formula and known data to migrate the static public key of the first entity, whilst retaining the assurance provided by said certificate, to form short-term public keys each for use, during a corresponding said limited operational period, in carrying out cryptographic operations for which there exist complimentary operations requiring use of the corresponding short-term private key.

32. A certificate authority of a public key infrastructure, the certificate authority being arranged to provide certificates each certifying an association between an identified entity and the public key of a static public/private key-pair the private key of which is held by the identified entity, at least one certificate also including a formula by which the corresponding public key is to be migrated to form short-term public keys each for use during a corresponding limited operational period in carrying out cryptographic operations pertaining to the identified entity concerned.
